(19) United States
(12) Patent Application Publication
(10) Pub. No.: US 2021/0272130 A1
(43) Pub. Date: Sep. 2, 2021

(54) AICS

(71) Applicant: Marvin K, Jones, Jacksonville, FL (US)

(72) Inventor: Marvin K, Jones, Jacksonville, FL (US)

(21) Appl. No.: 16/974,398

(22) Filed: Jan. 12, 2021

Related U.S. Application Data
(60) Provisional application No. 62/995,738, filed on Feb. 13, 2020.

(51) Int. Cl. G06Q 30/00; G06Q 50/10

(52) U.S. Cl. CPC G06Q 30/014; G06Q 50/10

(57) ABSTRACT

1. A System in which all recalls are transmitted to all daycares and child care centers on a daily basis in real time through a monitor, such as toys, food, furniture, and any other items that day care uses that is notified from any Federal Government Agency.

1. A System that is used to informed all Day Cares, and all Child Care Centers in the United States, and it's Territories concerning recalls such as food, toys, furniture, and any other items that Day Care Centers uses on a daily basis,

which they will be notified in real time on a desk top monitor from the FDA, simultaneously.

1. A Method of Communicating Recalls between all Daycares, and Childcare Centers Nationwide in the United States, and it's Territories for items that is recalled on a real time basis from all Government agencies for recalls on food, toys, furniture, and any other perishable items that a daycare uses on a daily basis.
